(19) United States
(12) Patent Application Publication
(10) Pub. No.: US 2005/0047362 A1
(43) Pub. Date: Mar. 3, 2005

(54) System and method for transmitting caller information from a source to a destination

(75) Inventors: John McFarland Harris, Chicago, IL (US); Philip Joseph Fleming, Glen Ellyn, IL (US); Jay Jayapalan, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/647,425

(22) Filed: Aug. 25, 2003

(51) Int. Cl. H04Q 7/00

(52) U.S. Cl. 370/328

(57) ABSTRACT

A system and method for transmitting information from a sender at a source mobile unit to a recipient at a destination mobile unit. A sender at a source mobile unit (102) may select a destination mobile unit (106). An overture element may then be formed. The overture element may contain information from the sender at the source mobile unit (102) indicating that the sender desires to establish a wireless connection with the recipient at the destination mobile unit (106). At least one data burst message may be formed and the overture element may be incorporated into the data burst message.

### FIELD OF THE INVENTION

The invention relates generally to two-way communication systems and more particularly to call initiation procedures.

### BACKGROUND OF THE INVENTION

Systems and methods for transmitting information in a wireless manner are well known. In a wireless system, a sender at a source mobile unit may send a communication to a recipient at a destination mobile unit. The communication will typically be transmitted from the source mobile unit to the destination mobile unit across a wireless infrastructure. Many wireless systems support communications of an “interconnect” type, whereby the sender dials a number, the recipient answers, and a communication session is created with no further interaction of the sender or the recipient required. In some cases, the wireless system will support communications of a “dispatch” or “push-to-talk” type, whereby both the sender and the recipient can push a single button on their respective devices to initiate an immediate (or nearly immediate) communication link.

One problem that arises in many types of wireless communications is presenting a recipient with an interruption when such call occurs. The recipient may not in fact wish to engage in all possible communications that might ensue upon responding to a given, incoming call. For example, the recipient may be otherwise occupied and may not wish to take the call from the sender at a certain time. As another example, the recipient may wish to avoid answering the particular sender altogether.

A dispatch service may be used to aid the recipient in determining whether they wish to establish a session with a sender. In using a dispatch service, the sender may press a button on a mobile wireless device, for example, a cellular telephone, and may wait for a beep in order to speak. Then, after the beep, the sender may speak a message and, thereafter, the message is transmitted to the recipient. After the message is received, it may be played to the recipient and the recipient can determine the identity of the sender. The recipient may then use this information to determine whether they want to take the call and establish a communication session with the sender.

In a typical interconnect-style communication service, however, such a capability does not exist. Instead, at best, most of today's telephone-style of communication systems offer a display of the telephone number for the calling party, the name of the calling party, or both. While such information can be helpful to a recipient when trying to decide whether to answer the call, such information lacks any contextual substance. In short, the recipient has no way of knowing whether the call will deal with a subject matter that is important to the recipient.

### BRIEF DESCRIPTION OF THE DRAWINGS

FIG. 1 is a block diagram of one example of a system in accordance with one embodiment of the invention;

FIG. 2 is a block diagram of one example of a mobile wireless unit in accordance with one embodiment of the invention;

FIG. 3 is a flowchart of one example of the operation of the system in accordance with one embodiment of the invention;

FIG. 4 is a flowchart of one example of the operation of the system in accordance with one embodiment of the invention;

FIG. 5 is a call-flow diagram of one example of the operation of the system in accordance with one embodiment of the invention; and

FIG. 6 is one example of a data burst message in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

Pursuant to many of these embodiments, a system and method for transmitting information from a sender at a source mobile unit to a recipient at a destination mobile unit is provided. A sender at a source mobile unit may select a destination mobile unit. An overture element may then be formed. In one embodiment, the overture element contains information from the sender at the source mobile unit indicating that the sender desires to establish a wireless connection with the recipient at the destination mobile unit. At least one data burst message may be formed and the overture element may be incorporated into the data burst message.

Pursuant to a preferred embodiment, a wireless connection may be established between the source mobile unit and the destination mobile unit. The at least one data burst message, described above, is transmitted over the wireless connection to the destination mobile unit.

Pursuant to another preferred approach, the data burst message transmitted from the source mobile unit is received at the destination mobile unit. The overture element from the at least one data burst message is extracted at the destination mobile unit. The information in the overture element is preferably evaluated, and, based upon the evaluation, a user may determine whether to establish the wireless connection between the sender and the recipient.

Thus, a system and method are provided whereby a recipient at a destination mobile unit can rapidly and easily determine the identity of a sender and/or purpose of a call. Further, the recipient can easily determine whether to establish a wireless session with the sender, and establish the session with a minimum of delay and without requiring further and constant interaction with the destination mobile unit. For example, the recipient can easily determine the identity of the sender, make a determination of whether to proceed with the call, and then, assuming the recipient desires to establish the session, quickly establish an interconnect call between the sender and the recipient without having to constantly push a “talk” button.

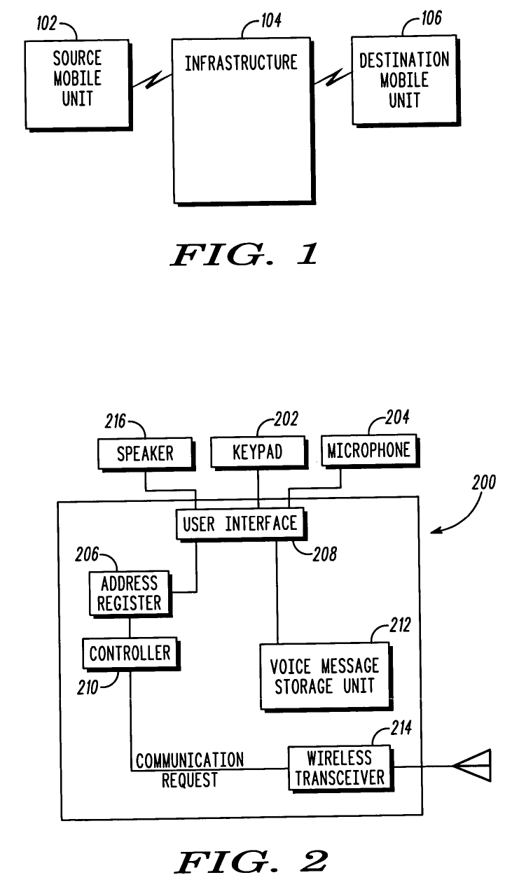

In one embodiment, the overture element includes speech, such as a short message as voiced by the sending party. So configured, the sending party can briefly inform the recipient of both the sending party's identity and the substantive nature of the desired communication. This, in turn, can be automatically be rendered audible at the receiving party's device as part of announcing the requested communication, thereby providing useful information that the receiving party can utilize to decide whether to answer the call. Referring initially to FIG. 1, a system for transmitting information from a sender at a source mobile unit to a recipient at a destination mobile unit includes a source mobile unit 102, a wireless infrastructure 104, and a destination mobile unit 106. The source mobile unit 102 is communicatively coupled to the wireless infrastructure 104. The wireless infrastructure 104 is communicatively coupled to the destination mobile unit 106.

The source and destination mobile units 102 and 106 may be any type of wireless communication device. For example, they may be any cellular phone, pager, personal digital assistant or any combination of these devices that is capable of transmitting and receiving information in a wireless manner. The mobile units 102 and 106 may conform to any standard or group of standards. In one example, the mobile units 102 and 106 may conform to the CDMA-2000 group of standards.

The wireless infrastructure 104 may be any type of telecommunication infrastructure that is used to establish wireless communication sessions between different mobile units. For example, the wireless infrastructure 104 may include switches, routers, base stations, and control units that transmit and route any type of communication between mobile units. The wireless infrastructure 104 may conform to any standard or group of standards. In one example, the wireless infrastructure 104 may conform to the CDMA-2000 group of standards.

In one example of the operation of the system of FIG. 1, a sender at the source mobile unit 102 selects a destination unit. The selection, for example, may be made by determining the telephone number of the recipient at the destination mobile unit. In another example, the number (or other information) of the destination mobile unit may be stored at the source mobile unit 102 and the sender may select this information.

In a preferred approach, the sending mobile unit 102 may form an overture element. The overture element may include any type of information that allows a sender to communicate information to the recipient. For example, the sender may record a voice message to be included as the overture element. The voice message may indicate that the sender wishes to establish a communication session with a recipient. In another example, the overture element may include information indicating (or comprising) a particular ringing tone to be played at the destination mobile unit. Conveniently, a particular ringing tone may be predefined to represent a particular sender and that sender's particular state and indicate to the recipient (by its unique audible tone) that the sender desires to establish a communication session with the recipient at the destination mobile unit 106. Other examples of information may also be included in the overture element. Further, the overture element may be spread across several data burst messages. This may become necessary because the information in the overture element is too large to be fitted into one message, for example, in the case of a long voice message. In addition, the sender may dynamically select the ringing tone that the destination mobile unit 106 will play at the time the sender places the call. Thus, the same caller may select different ringing tones for different calls placed to the same destination unit.

The source mobile unit 102 may form a data burst message and may incorporate the overture element into the data burst message. The data burst message may be sent across the infrastructure 104 to the destination mobile unit 106. The destination mobile unit 106 may receive the data burst message, extract the overture element from the data burst message, and present the information in the overture element to the recipient at the destination mobile unit. For example, the destination mobile unit may play the voice message in the overture element to the recipient. In another example, if the overture element contains the identification of a unique ringing tone, then the destination mobile unit may play the unique ringing tone to the recipient. The recipient may decide whether to establish a connection with the sender at the source mobile unit. Once the recipient indicates their decision, for example, by pushing a “talk” button, an interconnect call may be established between the source mobile unit and the destination mobile unit.

Thus, the recipient can easily determine the identity of the sender and readily make a determination of whether to proceed with the call. Assuming the recipient desires to establish a communication session, an interconnect call between the sender and the recipient can be quickly established. Once the recipient determines and indicates that they wish to establish the communication session with the sender, no additional steps (e.g., re-pushing the “talk” button) are required.

Referring now to FIG. 2, one example of a mobile unit suitable to support such actions is described. The mobile unit includes a keypad 202, a microphone 204, an address register 206, a user interface 208, a controller 210, a voice message storage unit 212, a wireless transceiver 214, and a speaker 216. The keypad 202, microphone 204, and speaker 216 are coupled to the user interface 208. The user interface 208 and the address register 206 are coupled to the controller 210. The controller 210 is coupled to the voice message storage unit 212 and the wireless transceiver 214. The voice message storage unit 212 is coupled to the user interface 208 and the wireless transceiver 214.

The keypad 202 may be any type of data entry device allowing a user to enter alphanumeric information. For example, it may be any of the well-known types of keypads used on cellular phones. In addition, it may be a voice-activated data entry unit or touch screen.

The microphone 204 may be any type of device that receives a human voice audio input and converts this input into an electrical signal. For instance, the microphone may be any type of standard microphone currently used with cellular phones.

The address register 206 may be any type of memory storage device that holds address information. It may include or be a part of any type of memory storage device. The address register 206 may be, in one example, a random access memory, and may be of a permanent or non-permanent form.

The user interface 208 may be any type of user interface device that is capable of converting electrical signals received from the keypad 202 and microphone 204 into a digital format that can be processed by a controller or microprocessor. The user interface 208 may also forward and/or convert signals for use by the speaker 216. The user interface 208 may perform other functions, as well. To accomplish its functions, the user interface 208 may be implemented using any combination of electronic hardware or computer software, as is known in the art.

The controller 210 may be any type of device that may be used to execute computer instructions stored in a memory. For example, the controller 210 may be a microprocessor including a memory or the like. In another example, the controller 210 may be a digital signal processor (DSP) or other similar device.

The voice message storage unit 212 may be any type of storage device that is capable of storing words or group of data that is to be transmitted. It may include or be a part of any type of memory storage device. The voice message storage unit 212 may be, in one example, a random access memory, and may be of a permanent or non-permanent form.

The wireless transceiver 214 may be any type of device that can transmit and receive data. The transceiver 214 may include an antenna that transmits or receives information. The transceiver 214 may convert data from the controller into a form compatible for transmission over its antenna. The transceiver 214 may also receive data and convert this data from an analog form into a digital form to be processed by the controller 210.

The speaker 216 may be any type of speaker that is capable of playing human voice or ringing patterns in an audio form to a human listener. For example, the speaker 216 may be any type of speaker that is used with cellular phones.

In one aspect of the operation of the device of FIG. 2, a sender selects a destination mobile unit. For example, the sender may use the keypad 202 to enter the telephone number of the recipient at the destination mobile unit. The information indicating the identity of the destination mobile unit may be communicated to the controller 210, which, based upon this information, and is known in the art, forms a destination address in the address register 206.

The sender may use the microphone 204 to record a voice message. The message may include any type of information they wish to communicate to the recipient. The controller 210 may also form an overture element from the voice message and incorporate the voice message into the overture element. It may be desirable to provide a time limit to govern the maximum permitted duration of such a voice message/overture element. In another example, the overture element may include information indicating a particular ringing tone to be played at the destination mobile unit. As yet another example, the overture element can comprise a particular ringing pattern to be played upon receipt of the overture element. Conveniently, such a particular ringing tone may be predefined to represent a particular sender and indicate to the recipient (by its unique audible tone) that the sender desires to establish a communication session with the recipient at the destination mobile unit.

The controller 210 may then form a data burst message, which incorporates the overture element and the destination address from the address register 206. This data burst message may be forwarded from the controller 210 to the wireless transceiver 214 via the communication request line.

The transceiver 214 may transmit the data burst message to the destination mobile unit via a wireless infrastructure. As is known in the art, the wireless infrastructure may route the data burst message to the correct destination mobile unit.

In another example of the operation of the wireless mobile unit of FIG. 2, a data burst message may be received at the wireless transceiver 214. For instance, the data burst message may be received via an antenna. The wireless transceiver 214 may convert the data burst message into a format that can be processed by the controller 210. The data burst message may be placed in the voice message storage unit 212 by the controller 210.

The controller 210 may extract the overture element from the data burst message in the voice message storage unit 212. The controller 210 may convert the overture element into an audio format at the user interface 208. The user interface 208 may automatically supply the overture element (now in audio form) to the speaker 216, which plays the overture element to the recipient. In another example, if the overture element contains the identification of a unique ring tone, then the destination mobile unit may extract the unique ringing tone identification from the overture element, and utilize this information to play the unique ringing tone to the recipient.

The recipient may then determine whether they wish to establish a communication session with the sender, for example, an interconnect call. If the recipient desires to establish an interconnect call with the recipient, this may be accomplished via the procedures described in the CDMA-2000 series of standards, as is known to those skilled in the art.

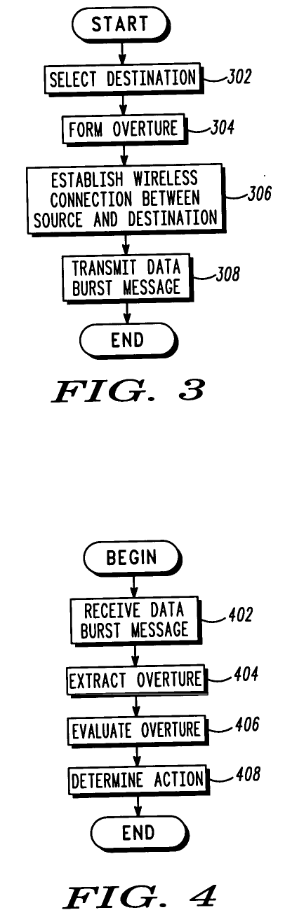

Referring now to FIG. 3, one example of a corresponding method is described. At step 302, the sender selects the destination mobile unit. For example, the sender may determine a destination telephone number. The user may enter this information on the keypad of a cellular phone, in one example.

At step 304, the source mobile unit may form an overture element. In one example, the sender may record a message at the source mobile unit and this message may form the overture element. In another example, the sender at the source mobile unit may select a ring type and supply this information to the source mobile unit via the keypad of the source mobile unit. The source mobile unit may then take this information, and convert it into an overture element.

At step 306, the source mobile unit may establish a wireless connection between the source mobile unit and the destination mobile unit. In one example, the source mobile unit may establish a traffic channel to be used to communicate the overture to the recipient at the destination mobile unit.

At step 308, the source mobile unit may form a data burst message. The data burst message may incorporate the overture element and the source mobile unit may transmit the data burst message to the destination mobile unit.

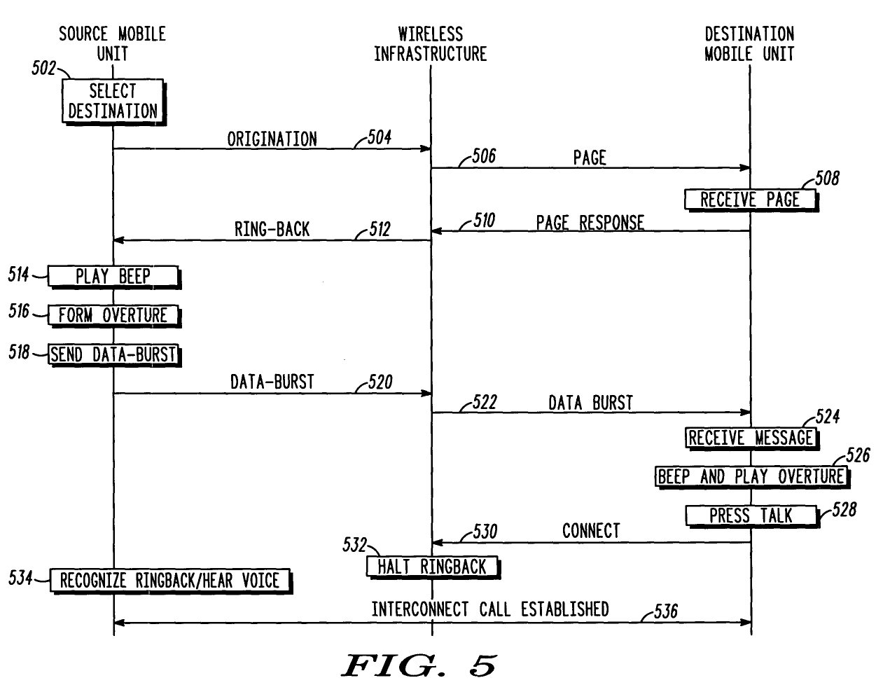

Referring now to FIG. 4, another example is described. At step 402, a destination mobile unit may receive a data burst message transmitted by a source mobile unit. For example, the destination mobile unit may receive the data burst message on an antenna.

At step 404, the destination mobile unit may extract the overture element from the data burst message. For example, the overture element may include a voice message, which is extracted. In another example, the overture element may be information indicating a ringing tone.

At step 406, the overture element may be processed and evaluated. In one example, after the extraction, the overture element may be converted into an audio form and played on a speaker to the recipient at the destination mobile unit. In another example, the information indicating the ringing tone may be extracted and the ringing tone may be played to the recipient. In yet another example, if the overture element contains both a voice message and a ringing tone, both the ringing tone and the voice message may be extracted an played to the recipient.

At step 408, an action is determined. In one example, the recipient determines whether they wish to establish a communication session with the sender. If the answer to establish a communication session is affirmative, then a communication session may be established. For example, an interconnect call may be established between the sender at the source mobile unit and the recipient at the destination mobile unit. On the other hand, if the determination to establish a communication session is negative, then the call from the sender may be routed to an alternate destination, for example, to a voice mail system.

Referring now to FIG. 5, another example of a corresponding method is described. At step 502, the sender may select the recipient. For example, the sender may determine the telephone number of the recipient and dial the selected number on the keypad of the sending mobile unit.

At step 504, the source mobile unit may send an origination request to the wireless infrastructure. At step 506, the wireless infrastructure may receive the origination request and then create and route a page to the destination mobile unit if it is registered and is available for an RF call. The page may also establish to that the user has been activated and/or is busy. In another example, the network may check its data to determine that the mobile is not busy. At step 508, the destination mobile unit (that is not busy), may receive the page. Since the destination mobile unit is not busy, then it responds to the page with a page response message. At step 510, the infrastructure may receive this message and, at step 512, the infrastructure may send a ring-back to the source mobile unit.

At step 514, the source mobile unit may play a beep to the sender at the source mobile unit. The playing of the beep indicates that the destination mobile unit is not busy or deactivated. At step 516, the source mobile unit may form an overture element. For example, the sender may announce their name, or present some other type of information indicating the purpose of the call. In another example, the sender may determine and select a particular ringing tone. This ringing tone may uniquely identify the sender and may be played at the destination mobile unit in conjunction with or instead of a voice message.

At step 518, the source mobile unit may form a data burst message including the overture. At step 520, the sending mobile unit may send the data burst message to the infrastructure. At step 522, the infrastructure may route and send the data burst message to the destination mobile unit.

At step 524, the destination mobile unit may receive the data burst message with the overture element. At step 526, the destination mobile unit may play a beep to a recipient and the message (or ring) from the overture element. At step 528, the recipient at the destination mobile unit may determine whether to engage the sender in a communication session. For example, the recipient at the destination mobile unit may press the “talk” button on the destination mobile unit. If the talk button is pressed, then at step 530 a connect message may be sent to the infrastructure. If the talk button is not pressed, the call from the sender at the sending mobile unit may be redirected to a different destination, for instance to voice mail system where the sender can record a message.

At step 532, the infrastructure halts playing ring back. At step 534, the source mobile unit may detect the absence of ring back and hear the recipient's voice. The termination of the ring-back tone may indicate to the sender that the recipient at the destination mobile unit desires that a communication session be established between the source mobile unit and the destination mobile unit. At step 536, an interconnect call may be established between the sender and the recipient.

Thus, a recipient at a destination mobile unit can easily determine the identity of the sender and make a determination of whether to proceed with the call. Assuming the recipient desires to establish the session with the sender, an interconnect call can quickly be established between the sender and the recipient with a minimum of intervention or effort on the part of the recipient.

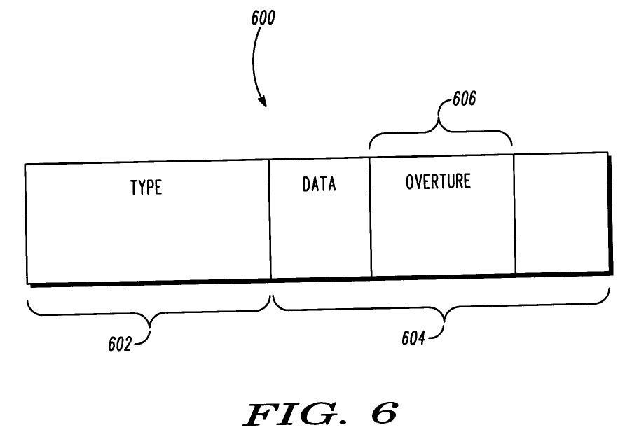

Referring now to FIG. 6, one illustrative example of an data burst message 600 is described. The data burst message 600 may include a data burst type field 602 and a data field 604. The data field 604 may include an overture element 606. The data burst message 600 may include other types of fields as well, but is shown here as having only two fields.

The data burst type field 602 may include values indicating the type of data burst. For example, according to the CDMA 2000 family of standards, the field may include six bits. One value (e.g., “000011”) may indicate a short message services as the type assignment. A subtype field (within the data burst type field 602) may indicate the nature of the processing to the destination mobile unit. For example, the three leading bits may be used along with the other information to indicate that the data burst message includes either voice data, ringing data, or some other type of information where special processing is required.

A predefined value (e.g., “111111”) of the data burst type field 602 may indicate that an extended burst type is contained in the first two octets of the data field 604. The extended burst type, therefore, may indicate that a proprietary message type is being used in the data field 604. In one example, an extended type may indicate that voice data is present in the data field while, in another example, the value of the extended type may indicate that ringing-type data is included elsewhere in the data field.

The overture element 606 may include any type of information indicating that a sender wishes to establish a communication session with a recipient. In one example, the overture element may include a voice message. In another example, the overture element may include information indicating a ringing tone. Although shown here as being part of the data field 604, the overture element 606 may include all of the data field 604. In addition, although shown here as being part of a single data burst message, the overture element 606 may be spread across multiple data burst messages.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention. For example, it may be desirable to provide the communication device with a mute button or other mechanism to allow a recipient to quickly and conveniently terminate the overture element during playback when desired.

1. A method for transmitting information from a sender at a source mobile unit to a recipient at a destination mobile unit, the method comprising:
selecting a destination mobile unit;
forming an overture element, the overture element containing information from the sender at the source mobile unit indicating that the sender desires to establish a wireless connection with the recipient at the destination mobile unit; and
forming at least one data burst message incorporating the overture element.

2. The method of claim 1 comprising:
establishing a wireless connection between the source mobile unit and the destination mobile unit; and
transmitting the at least one data burst message over the wireless connection to the destination mobile unit.

3. The method of claim 2 comprising:
receiving the data burst message at the destination mobile unit;
extracting the overture element from the at least one data burst message; and
evaluating the information in the overture element; and
determining whether to establish the wireless connection based upon the information in the overture element.

4. The method of claim 3 wherein forming the overture element comprises forming a voice message.

5. The method of claim 4 wherein evaluating the information in the overture element comprises playing the voice message to the recipient and wherein determining whether to establish a wireless connection comprises waiting a predetermined period of time for the recipient to initiate the formation of a response.

6. The method of claim 5 comprising establishing an interconnect call between the source mobile unit and the destination mobile unit if the recipient determines to establish a wireless connection.

7. The method of claim 1 wherein forming at least one data burst message comprises forming two or more data burst messages.

8. A method of establishing a wireless connection between a source mobile unit and a destination mobile unit comprising:
receiving at least one data burst message at the destination mobile unit;
extracting an overture element from the at least one data burst message; and
evaluating the information in the overture element and determining whether to establish the wireless connection.

9. The method of claim 8 wherein extracting the overture comprises extracting a voice message.

10. The method of claim 9 wherein evaluating the information in the overture element comprises playing the voice message to the recipient and waiting for a predetermined amount of time for the recipient to establish a wireless connection with the source mobile unit.

11. The method of claim 10 comprising muting a microphone at the destination mobile unit when the recipient establishes the wireless connection with the source mobile unit.

12. The method of claim 11 comprising establishing an interconnect call between the source mobile unit and the destination mobile unit after the recipient determines to establish the wireless connection with the source mobile unit.

13. The method of claim 8 wherein receiving the at least one data burst message comprises receiving two or more data burst messages.

14. A system for communication between a sender at a source mobile unit and a recipient at a destination mobile unit comprising:
a source mobile unit, the source mobile unit forming an overture element, the overture element having information indicating that the sender desires to establish a communication session with the recipient, the source mobile unit forming and providing at least one data burst message incorporating the overture element; and
a wireless telecommunications infrastructure being operably coupled to the source mobile unit and a destination mobile unit, the wireless telecommunication infrastructure transmitting the at least one data burst message from the source mobile unit to the destination mobile unit, the destination mobile unit receiving the at least one data burst message, extracting the information from the overture element in the at least one data burst message, and presenting the information to the recipient at the destination mobile unit.

15. The system of claim 14 wherein the at least one data burst message comprises two or more data burst messages.

16. The system of claim 14 wherein the destination mobile unit comprises a microphone that is muted if the recipient determines to establish the communication session with the sender.

17. The system of claim 14 wherein the wireless telecommunication infrastructure transmits the data burst message according to the CDMA 2000 protocol.

18. The system of claim 17 wherein the destination mobile unit operates in a plurality of call-processing states and sub-states, at least one of which is a waiting for order sub-state, and the destination mobile unit is operating in the waiting for order sub-state during the receipt of the at least one data burst message.

19. A two-way wireless communication device comprising:
a wireless transceiver having at least a data burst output;
a user interface that comprises at least an audio input;
a voice message storage unit operably coupled to the user interface;
at least one register containing an address for a destination mobile unit;
a controller that is operably coupled to the user interface, the voice message storage unit, and the at least one register and having a communication request output comprising at least a portion of the contents of the at least one register and at least a portion of a voice message as stored in the voice message storage unit, wherein the communication request output is operably coupled to the wireless transceiver; and
such that the wireless transceiver will transmit a data burst that comprises the communication request output.

20. The two-way communication device of claim 19 wherein the controller comprises controller means for forming an overture element, the overture element containing information from the sender at the source mobile unit indicating that the sender desires to establish a wireless connection with the recipient at the destination mobile unit.

21. The two-way communication device of claim 19 wherein the controller comprises controller means for forming at least one data burst message incorporating the overture element.

22. A call initiation mechanism at a destination mobile unit comprising:
a wireless transceiver having at least a data burst input from a source mobile unit;
a voice message storage unit operably coupled to the wireless transceiver;
an interface having an audio output;
a controller that is operably coupled to the voice message storage unit, and having a communication output comprising at least a portion of at least one data burst message as stored in the voice message storage unit, the controller being coupled to the interface by the communication output;
such that the interface presents an audio representation of at least a portion of the at least one data burst message to a recipient.

23. The call initiation mechanism of claim 22 wherein the user interface comprises a control input indicating whether the user desires to respond to the audio representation of the at least one portion of the at least one data burst message.

24. The call initiation mechanism of claim 23 wherein the controller comprises means for establishing an interconnect call between the destination mobile unit and the source mobile unit.
